(19) United States
(12) Patent Application Publication
(10) Pub. No.: US 2007/0187083 A1
(43) Pub. Date: Aug. 16, 2007

(54) Apparatus for air conditioning using power frequency carrier

(75) Inventor: Yuan-Yu Huang, Taipei City (TW)

Correspondence Address: TROXELL LAW OFFICE PLLC, 5205 LEESBURG PIKE, SUITE 1404, FALLS CHURCH, VA, 22041, US

(73) Assignee: HANSDER ENGINEERING CO., LTD., Taipei City (TW)

(21) Appl. No.: 11/594,250

(22) Filed: Nov. 8, 2006

(30) Foreign Application Priority Data
Dec. 2, 2005 (TW) 094221069

(51) Int. Cl. B60H 1/00

(52) U.S. Cl. 165/202

(57) ABSTRACT

The present invention provides an apparatus for air conditioning, where components of the apparatus are easily installed and communicate with each other easily by using power frequency carrier for better performance.

### FIELD OF THE INVENTION

The present invention relates to air conditioning; more particularly, relates to easily installing and communicating a sensor, a comparator, an actuator and an air conditioner without complex wirings.

### DESCRIPTION OF THE RELATED ART

When using a general air conditioner to control environment temperature, a sensor is used to sense an environment temperature to be transformed into a pneumatic pressure or a voltage. A comparator is used to compare the pneumatic pressure or voltage with desired pneumatic pressure or voltage. If the two pneumatic pressure or voltage are different, an actuator actuates a valve, a baffle or a similar component to control a wind flow of the air conditioner so that the environment temperature is changed.

Yet, components for the general air conditioner are varied. The controller for the sensor or the actuator may be a pneumatic, electric or electronic one, which can be a fluid valve, an air valve, a baffle to limit air flow, a manual pressure controller to control air flow, a pressure controller to control work flow (e.g. a steam), a differential pressure controller, a fluid-velocity sensor, a temperature controller, a temperature-signal transmitter, a signal-receiver controller, a humidity controller, a main controller with auxiliary controllers, a counter-current relay to control pressure, a pressure selector, a pneumatic electric switch, a refrigeration controller, etc. Besides, the components need to be connected with wirings, so that the wirings become complex and the installation is not easy. Hence, the prior art does not fulfill users' requests on actual use.

### SUMMARY OF THE INVENTION

The main purpose of the present invention is to easily install and communicate a sensor, a comparator, an actuator and an air conditioner without complex wirings.

To achieve the above purpose, the present invention is an apparatus for air conditioning using power frequency carrier, comprising a sensor having a power frequency carrier device; a comparator having a power frequency carrier device to receive data from the sensor for an operation; an actuator having a power frequency carrier device to receive data from the comparator for an actuation; and an air conditioner using a damper of each wind pipe, where the damper is connected with an actuator and is control led to open wider or close narrower by the actuator. Accordingly, a novel apparatus for air conditioning using power frequency carrier is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is a block view of a preferred embodiment according to the present invention;

FIG. 2 is a block view showing a power frequency carrier device according to the preferred embodiment of the present invention; and

FIG. 3 is a block view showing a state of use of the preferred embodiment according to the present invention;

### DESCRIPTION OF THE PREFERRED EMBODIMENTS

The following description of the preferred embodiment is provided to understand the features and the structures of the present invention.

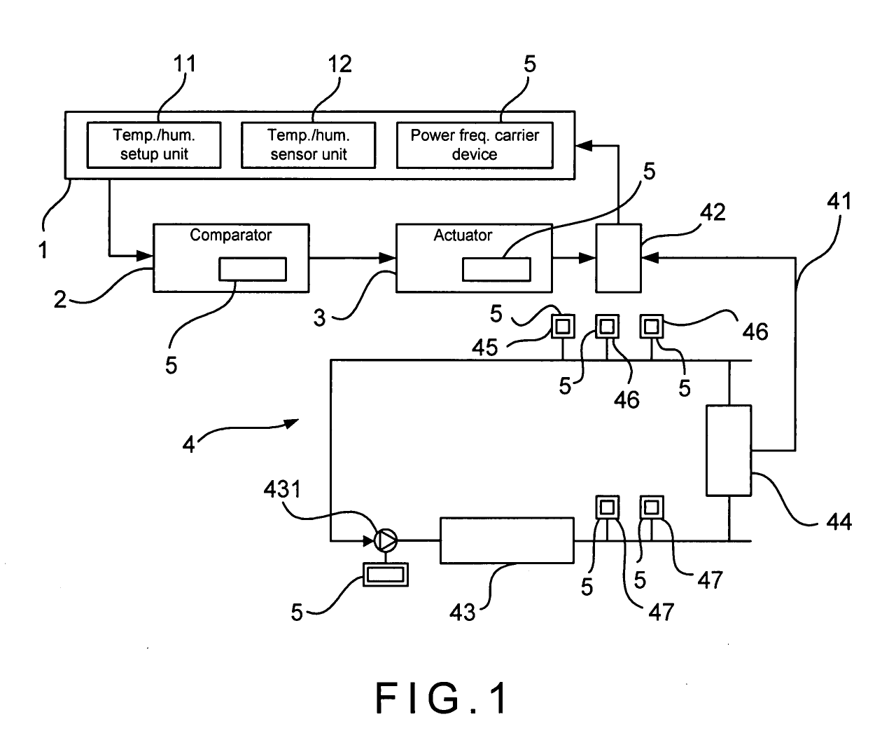

Please refer to FIG. 1, which is a block view of a preferred embodiment according to the present invention. As shown in the figure, the present invention is an apparatus for air conditioning using power frequency carrier, comprising a sensor 1, a comparator 2, an actuator 3 and an air conditioner 4, where the sensor 1, the comparator 2, the actuator 3 and the air conditioner 4 are installed easily without complex wirings.

The sensor 1 has a power frequency carrier device 5; and the sensor 1 comprises a temperature/humidity setup unit 11 and a temperature/humidity sensor unit 12.

The comparator has a power frequency carrier device 5 to receive data from the sensor 1 for a required operation.

The actuator 3 has a power frequency carrier device 5 to receive data from the comparator 2 for an actuation.

The air conditioner 4 has a wind pipe 41 with a damper 42. The damper 42 is connected with the actuator 3 to open wider or close narrower 42. The air conditioner has a chiller 43 with a diverter pump; and the chiller 43 is connected with a cooling load 44 of the wind pipe 41, where each diverter pump 431, each flow meter 45, each return-water thermometer 46 and each supply-water thermometer respectively has a power frequency carrier device 5 while plugging in an indoor power socket. Thus, a novel apparatus for air conditioning using power frequency carrier is obtained.

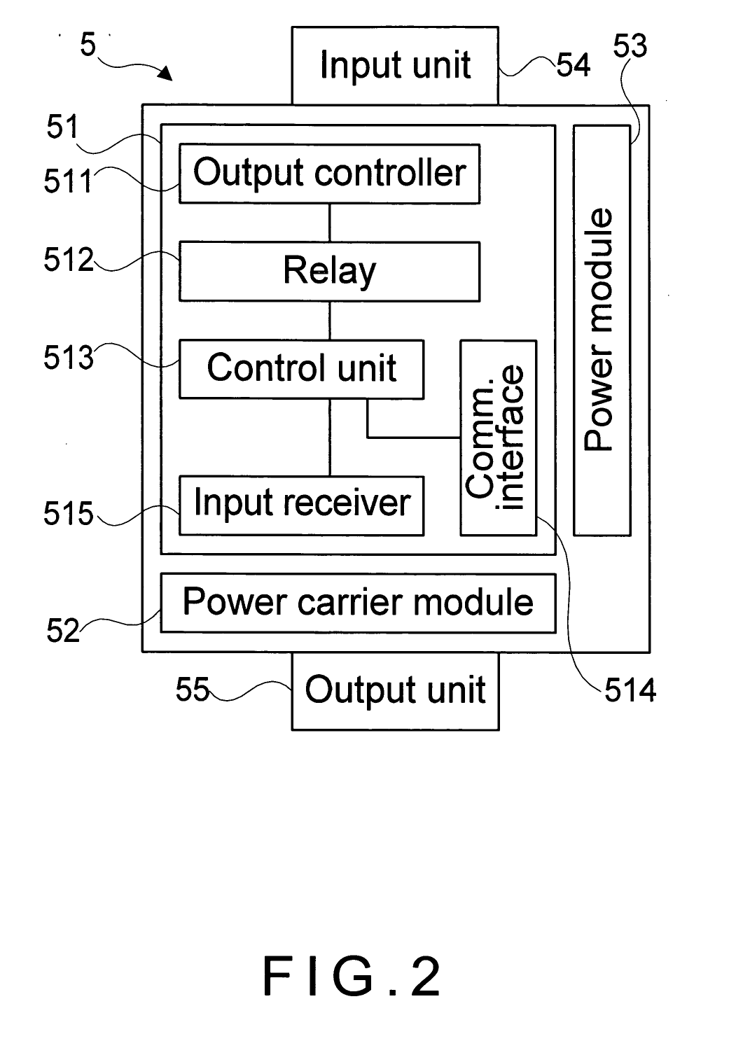

Please refer to FIG. 2, which is a block view showing a power frequency carrier device according to the preferred embodiment of the present invention. As shown in the figure, a power frequency carrier device 5 in every sensor 1, comparator 2 or actuator 3 comprises a single-chip control module 51; a power carrier module 52 having a transmission rate of 1200 BPS (bit per second); an electricity module 53 providing required power for the single-chip control module 51 and the power carrier module; an input unit 54; and an output unit 55, where the single-chip control module 51 comprises an output controller 511, a relay 512, a control unit 513, a communication interface 514 and an input receiver 515.

There in, the control unit 513 of the power frequency carrier device 5 is a 8051 single-chip as a processing unit with a good inner structure, whose working frequency is up to 16 MHz with a 4k size of electrically programmable and erasable ROM (Read Only Memory) together with eight input pins and eight output pins. The relay 512 is located at the output pins of the 8051 single-chip to quarantine the circuit for securing and ensuring the operation of the single-chip control module 51. The 8051 single-chip contains the full-duplex communication interface 514 inside. The communication interface 514 is an RS232 interface to simultaneously transfer and receive data to and from outside. The operational signals in the 8051 single-chip are on a TTL (transistor-transistor-logic) level (0 voltage set as logic 0 and +5 voltage set as logic 1) and the communication interface 514 is a serial communication interface to transfer and receive data in a form of bit series.

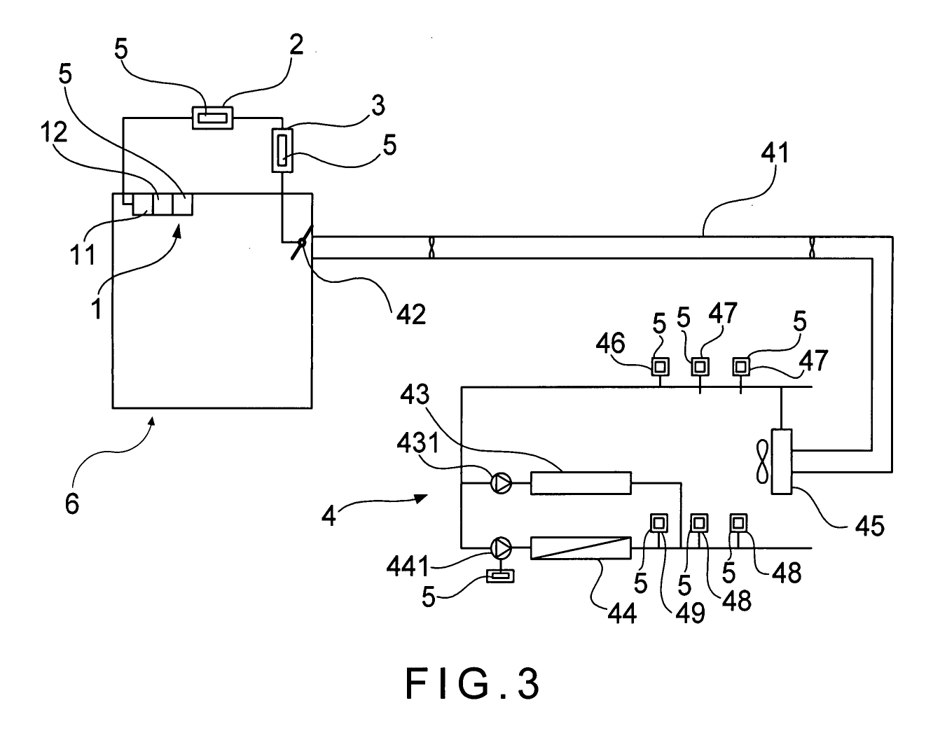

Please further refer to FIG. 3, which is a block view showing a state of use of the preferred embodiment according to the present invention. As shown in the figure, when using the present invention, the sensor 1, the comparator 2 and the actuator 3 are respectively plugged in indoor power sockets in a room or zone 6, where each sensor 1, comparator 2 or actuator 3 has a power frequency carrier device 5. Moreover, an air conditioner 4 is set in a building's basement or a required place; a wind pipe 41 is set to a wind hole of the room or zone 6; and, a damper 42 connecting to the actuator 3 is set to a mouth of the wind pipe 41. At first, a required temperature and/or humidity (temperature/humidity) is setup by using a temperature/humidity setup unit 11 of the sensor 1. A cool air or a warm air is blown to each room or zone 6 through the wind pipe 41 by the air conditioner 4. After a period of time, a temperature/humidity sensor unit 12 senses the temperature/humidity of the room or zone 6; then, the sensed temperature/humidity of the room or zone 6 are transferred from the power frequency carrier device 5 to the comparator 2 to be compared with the setup temperature/humidity. If the sensed temperature/humidity and the setup temperature/humidity are the same the comparator 2 sends a signal to the actuator 3 to prevent the damper from opening wider or closing narrower; if the sensed temperature/humidity is higher than the setup temperature/humidity, the comparator 2 sends a signal to the actuator 3 to open the damper wider for blowing out more wind; and, if the sensed temperature/humidity is lower than the setup temperature/humidity, the comparator 2 sends a signal to the actuator 3 to close the damper narrower for blowing out less wind.

In the other hand, when operating the air conditioner 4, a velocity of the diverter pump 431 of the chiller 43 is changed according to the temperature of a supply water, where the temperature of the supply water is sensed by the return-water thermometer 47 and the supply-water thermometer 47 and signals representing the temperature is transferred through power frequency carrier devices. Thus, the air flows at the primary side and the secondary side of the air conditioner 4 are equalized.

When using the power frequency carrier device 5 to transfer a signal, the signal is integrated with an electricity and is encoded by the single-chip control module 51, the power carrier module 52 and the electricity module. A transmission mode and a transmission speed are detected and setup by the single-chip control module 51 to transfer the signal together with the electricity through the indoor power socket by using the output unit 55 of the power frequency carrier device 5. Then, the signal together with the electricity is received by the in put unit 54 of the power frequency carrier device 5 of another element (such as the sensor 1, the comparator 2, the actuator 3, the diverter pump 431, the flow meter 45, the return-water thermometer 46 and the supply-water thermometer 47) to be decoded and de-integrated by the single-chip control module 51, the power carrier module 52 and the electricity module 53. The signal received is then ascertained. If the signal is recognizable, the element is actuated; and, if the signal is not recognizable, the element is not actuated even though the signal is transferred in.

To sum up, the present invention is an apparatus for air conditioning using power frequency carrier, where a sensor, a comparator, an actuator and an air conditioner communicate by using power frequency carrier devices without complex wirings and are easily installed.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An apparatus for air conditioning using power frequency carrier,
comprising:
(a) a sensor having a power frequency carrier device;
(b ) a comparator having a power frequency carrier device;
(c) an actuator having a power frequency carrier device; and
(d) an air conditioner using a wind pipe,
wherein said sensor, said comparator and said actuator respectively connect to indoor power sockets;
wherein said comparator receives data from said sensor for an operation and said actuator receive data from said comparator for an actuation; and
wherein said air conditioner connects to said actuator and said actuator controls a switching-on and a switching-off of said damper.

2. The apparatus according to claim 1,
wherein said sensor comprises a temperature-and-or-humidity setup unit and a temperature-and-or-humidity sensor unit.

3. The apparatus according to claim 1,
wherein each of said power frequency carrier devices, which are in a device selected from a group consisting of said sensor, said comparator and said actuator, comprises a single-chip control module, a power carrier module, an electricity module, an output unit and an input unit.

4. The apparatus according to claim 3,
wherein said single-chip control module comprises an input receiver, an output controller, a control unit, a communication interface and a relay.

5. The apparatus according to claim 4,
wherein said control unit is a 8051 single-chip.

6. The apparatus according to claim 4,
wherein said control unit has a working frequency of 16 MHz (megahertz).

7. The apparatus according to claim 4,
wherein said communication interface is a RS232 interface.

8. The apparatus according to claim 3,
wherein said power carrier module has a transmission rate of 1200 BPS (bit per second).

9. The apparatus according to claim 1,
wherein said air conditioner has a chiller and said chiller has a diverter pump;
wherein said wind pipe has a cooling load;
wherein said chiller connects to said cooling load; and
wherein a flow meter, a return-water thermometer and a supply-water thermometer are serially connected between said chiller and said cooling load.

10. The apparatus according to claim 9,
wherein each of said diverter pump, said flow meter, said return-water thermometer and said supply-water thermometer has a power frequency carrier device and connects to an indoor power socket.
